(19) United States
(12) Patent Application Publication
(10) Pub. No.: US 2008/0259085 A1
(43) Pub. Date: Oct. 23, 2008

(54) Method for Animating an Image Using Speech Data

(75) Inventors: Gui-Lin Chen, Shanghai (CN); Jian-Cheng Huang, Mendham, NJ (US); Duan-Duan Yang, Guanzhou (CN)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/147,840

(22) Filed: Jun. 27, 2008

(30) Foreign Application Priority Data
Dec. 29, 2005 (CN) 200510135748.3

(51) Int. Cl. G06T 15/70

(52) U.S. Cl. 345/473

(57) ABSTRACT

A method for animating an image is useful for animating avatars using real-time speech data. According to one aspect, the method includes identifying an upper facial part and a lower facial part of the image (step 705); animating the lower facial part based on speech data that are classified according to a reduced vowel set (step 710); tilting both the upper facial part and the lower facial part using a coordinate transformation model (step 715); and rotating both the upper facial part and the lower facial part using an image warping model (step 720).

### FIELD OF THE INVENTION

The present invention relates generally to computationally efficient methods for animating images using speech data. In particular, although not exclusively, the invention relates to animating multiple body parts of an avatar using both processes that are based on speech data and processes that are generally independent of speech data.

### BACKGROUND OF THE INVENTION

Speech recognition is a process that converts acoustic signals, which are received for example at a microphone, into components of language such as phonemes, words and sentences. Speech recognition is useful for many functions including dictation, where spoken language is translated into written text, and computer control, where software applications are controlled using spoken commands.

A further emerging application of speech recognition technology is the control of computer generated avatars. According to Hindu mythology, an avatar is an incarnation of a god that functions as a mediator with humans. In the virtual world of electronic communications, avatars are cartoon-like, “two dimensional” or “three dimensional” graphical representations of people or various types of creatures. As a “talking head”, an avatar can enliven an electronic communication such as a voice call or email by providing a visual image that presents the communication to a recipient. For example, text of an email can be “spoken” to a recipient through an avatar using speech synthesis technology. Also, a conventional telephone call, which transmits only acoustic data from a caller to a callee, can be converted to a quasi video conference call using speaking avatars. Such quasi video conference calls can be more entertaining and informative for participants than conventional audio-only conference calls, but require much less bandwidth than actual video data transmissions.

Quasi video conferences using avatars employ speech recognition technology to identify language components in received audio data. For example, an avatar displayed on a screen of a mobile phone can animate the voice of a caller in real-time. As the caller's voice is projected over a speaker of the phone, speech recognition software in the phone identifies language components in the caller's voice and maps the language components to changes in the graphical representation of a mouth of the avatar. The avatar thus appears to a user of the phone to be speaking, using the voice of the caller in real-time.

In addition to animating a graphical representation of a mouth, prior art methods for animating avatars include complex algorithms to simultaneously synchronize multiple body movements with speech. Such multiple body movements can include eye movements, mouth and lip movements, rotating and tilting head movements, and torso and limb movements. However, the complexity of the required algorithms makes such methods generally infeasible for animations using real-time speech data, such as voice data from a caller that is received in real-time at a phone.

### SUMMARY OF THE INVENTION

According to one aspect, the present invention is a method for animating an image, including identifying an upper facial part and a lower facial part of the image; animating the lower facial part based on speech data that are classified according to a reduced vowel set; tilting both the upper facial part and the lower facial part using a coordinate transformation model; and rotating both the upper facial part and the lower facial part using an image warping model.

According to another aspect, the present invention is a method for animating an image, including identifying an upper facial part and a lower facial part of the image; animating the lower facial part based on speech data that are classified according to a reduced vowel set; and animating the upper facial part independently of animating the lower facial part.

Thus, using the present invention, improved animations of avatars are possible using real-time speech data. The methods of the present invention are less computationally intensive than most conventional speech recognition and animation methods, which enables the methods of the present invention to be executed faster while using fewer processor resources.

### BRIEF DESCRIPTION OF THE DRAWINGS

In order that the invention may be readily understood and put into practical effect, reference now will be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a schematic diagram illustrating a mobile device in the form of a radio telephone that performs a method of the present invention;

FIG. 2 is a cartoon image illustrating an avatar including an upper facial part, a lower facial part, and limb parts, according to an embodiment of the present invention;

FIG. 3 is a schematic diagram illustrating an animation series including lower facial part visemes that are used to animate the lower facial part of an avatar, according to an embodiment of the present invention;

FIG. 4 is a schematic diagram illustrating tilting of a head portion comprising an upper facial part and a lower facial part of an avatar, according to an embodiment of the present invention;

FIG. 5 is a schematic diagram illustrating rotation of a head portion comprising an upper facial part and a lower facial part of an avatar, according to an embodiment of the present invention;

FIG. 6 is a functional block diagram illustrating a method for animating an image, according to an embodiment of the present invention; and

FIG. 7 is a generalized flow diagram illustrating a method for animating an image, such as a cartoon image of an avatar, according to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to methods for animating an image using speech data. Accordingly, the apparatus components and method steps have been represented where appropriate by conventional symbols in the drawings, showing only those specific details that are pertinent to understanding the embodiments of the present invention, so as not to obscure the disclosure with details that will be readily apparent to those of ordinary skill in the art having the benefit of the description herein.

In this document, relational terms such as left and right, first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

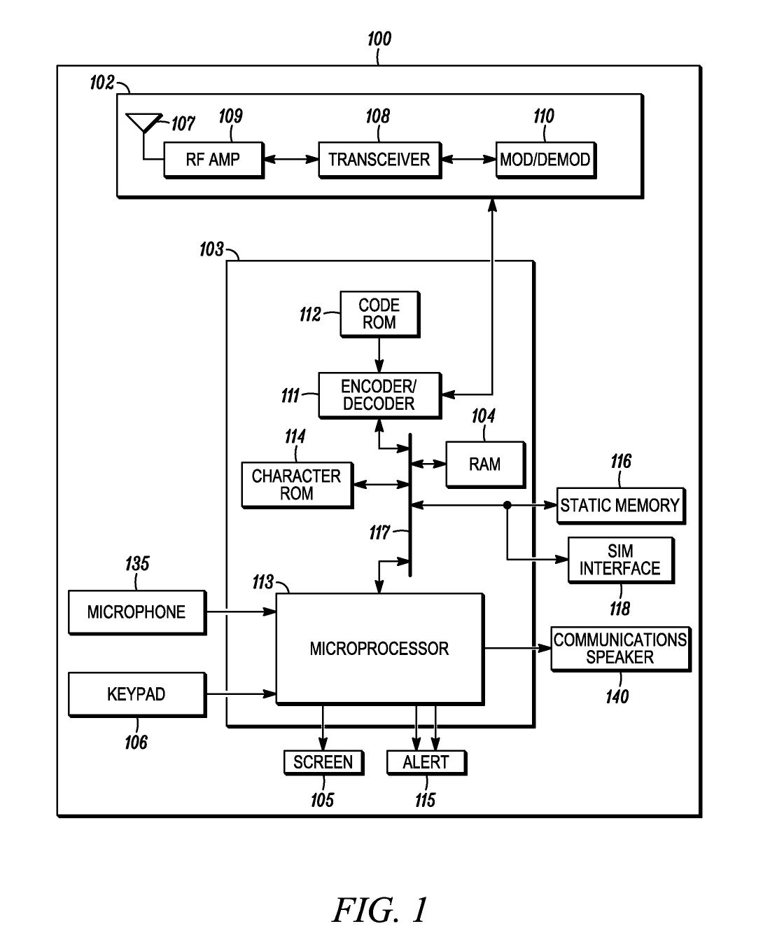

Referring to FIG. 1, a schematic diagram illustrates a mobile device in the form of a radio telephone 100 that performs a method of the present invention. The telephone 100 comprises a radio frequency communications unit 102 coupled to be in communication with a processor 103. The telephone 100 also has a keypad 106 and a display screen 105 coupled to be in communication with the processor 103. As will be apparent to a person skilled in the art, screen 105 may be a touch screen thereby making the keypad 106 optional.

The processor 103 includes an encoder/decoder 111 with an associated code Read Only Memory (ROM) 112 storing data for encoding and decoding voice or other signals that may be transmitted or received by the radio telephone 100. The processor 103 also includes a micro-processor 113 coupled, by a common data and address bus 117, to the encoder/decoder 111, a character Read Only Memory (ROM) 114, a Random Access Memory (RAM) 104, static programmable memory 116 and a SIM interface 118. The static programmable memory 116 and a SIM operatively coupled to the SIM interface 118 each can store, amongst other things, selected incoming text messages and a Telephone Number Database TND (phonebook) comprising a number field for telephone numbers and a name field for identifiers associated with one of the numbers in the name field. For instance, one entry in the Telephone Number Database TND may be 91999111111 (entered in the number field) with an associated identifier “Steven C! at work” in the name field.

The micro-processor 113 has ports for coupling to the keypad 106 and screen 105 and an alert 115 that typically contains an alert speaker, vibrator motor and associated drivers. Also, micro-processor 113 has ports for coupling to a microphone 135 and communications speaker 140. The character Read only memory 114 stores code for decoding or encoding text messages that may be received by the communications unit 102. In this embodiment the character Read Only Memory 114 also stores operating code (OC) for the micro-processor 113 and code for performing functions associated with the radio telephone 100.

The radio frequency communications unit 102 is a combined receiver and transmitter having a common antenna 107. The communications unit 102 has a transceiver 108 coupled to antenna 107 via a radio frequency amplifier 109. The transceiver 108 is also coupled to a combined modulator/demodulator 110 that couples the communications unit 102 to the processor 103.

Conventional speech recognition processes address the complex technical problem of identifying phonemes, which are the smallest vocal sound units that are used to create words. Speech recognition is generally a statistical process that requires computationally intensive analysis of speech data. Such analysis includes recognition of acoustic variabilities like background noise and transducer-induced noise, and recognition of phonetic variabilities like the acoustic differences in individual phonemes. Prior art methods for animating avatars combine such computationally intensive speech recognition processes with computationally intensive body part animation processes, where the body part animation processes are synchronized with speech data. Such methods are generally too computationally intensive for use on mobile devices such as the radio telephone 100, particularly where speech data need to be processed in real-time.

According to one embodiment, the present invention is a method, which is significantly less computationally intensive than conventional animation methods, for animating an image to create a believable and authentic-looking avatar. For example, an avatar can be displayed on the screen 105 of the phone 100, and appear to be speaking in real-time the words of a caller that are received by the transceiver 108 and amplified over the communications speaker 140. Further, the avatar can exhibit—as it “speaks”—natural looking movements of its body parts including, for example, its head, eyes, mouth, torso and limbs. Such a method is described in detail below.

First, speech data are filtered by identifying voiced speech segments of the speech data. Identifying voiced speech segments can be performed using various techniques known in the art such as energy analyses and zero crossing rate analyses. High energy components of speech data are generally associated with voiced sounds, and low to medium energy speech data are generally associated with unvoiced sounds. Very low energy components of speech data are generally associated with silence or background noise.

Zero crossing rates are a simple measure of the frequency content of speech data. Low frequency components of speech data are generally associated with voiced speech, and high frequency components of speech data are generally associated with unvoiced speech.

After voiced speech segments are identified, a high-amplitude spectrum is determined for each segment. Thus, for each segment, normalized Fast Fourier Transform (FFT) data are determined by normalizing according to amplitude an FFT of a high-amplitude component of each voiced speech segment. The normalized FFT data are then filtered so as to accentuate peaks in the data. For example, a high-pass filter having a threshold setting of 0.1 can be applied, which sets all values in the FFT data that are below the threshold setting to zero.

The normalized and filtered FFT data are then processed by one or more peak detectors. The peak detectors detect various attributes of peaks such as a number of peaks, a peak distribution and a peak energy. Using data from the peak detectors, the normalized and filtered FFT data, which likely represent a high-amplitude spectrum of a main vowel sound, are then divided into sub-bands. For example, according to one embodiment of the present invention four sub-bands are used, which are indexed from 0 to 3. If the energy of a high-amplitude spectrum is concentrated in sub-band 1 or 2, the spectrum is classified as most likely corresponding to a main vowel phoneme /a/. If the energy of the high-amplitude spectrum is concentrated in sub-band 0 and 2, the spectrum is classified as most likely corresponding to a main vowel phoneme /i/. Finally, if the energy of the high-amplitude spectrum is concentrated in sub-band 0, the spectrum is classified as most likely corresponding to a main vowel phoneme /u/.

According to one embodiment of the present invention, the classified spectra are used to animate features of an avatar so as to create the impression that the avatar is actually “speaking” the speech data. Such animation is performed by mapping the classified spectra to discrete mouth movements. As is well known in the art, discrete mouth movements can be replicated by an avatar using a series of visemes, which essentially are basic speech units mapped into the visual domain. Each viseme represents a static, visually contrastive mouth shape, which generally corresponds to a mouth shape that is used when a person pronounces a particular phoneme.

The present invention can efficiently perform such phoneme-to-viseme mapping by exploiting the fact that the number of phonemes in a language is much greater than the number of corresponding visemes. Further, the main vowel phonemes /a/, /i/, and /u/ each can be mapped to one of three very distinct visemes. By using only these three distinct visemes—coupled with image frames of a mouth moving from a closed to an open and then again to a closed position—cartoon-like, believable mouth movements can be created. Because only three main vowel phonemes are recognized in the speech data, the speech recognition of embodiments of the present invention is significantly less processor intensive than prior art speech recognition. For example, various vowel phonemes in the English language are all grouped, according to an embodiment of the present invention, into reduced vowel sets using the three main vowel phonemes of /a/, /i/, and /u/, as shown in Table 1 below.

TABLE 1
Reduced Vowel Sets in English

| | |
|---|---|
| /a/ | ax, aa, ae, ao, aw, er, ay, eh, ey |
| /i/ | ih, iy |
| /u/ | ow, oy, uh, uw |

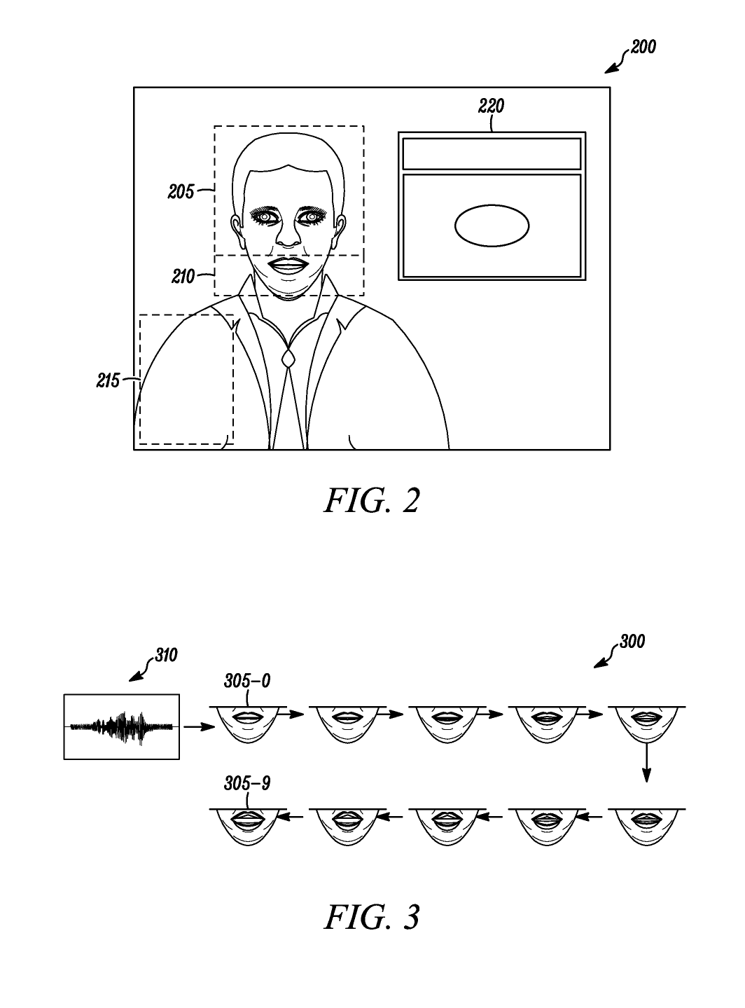

Referring to FIG. 2, a cartoon image 200 illustrates an avatar including an upper facial part 205, a lower facial part 210, and limb parts 215, according to an embodiment of the present invention. The cartoon image 200 also includes a background part 220. To animate the avatar so that it appears to be speaking in a natural, human-like manner, it is helpful to animate all of the upper facial part 205, comprising, e.g., eyes, hair and eyebrows; lower facial part 210, comprising, e.g., a mouth and lips; and limb parts 215, comprising, e.g., legs, arms, and hands. As described above, the lower facial part 210 can be effectively and efficiently animated using speech data that are classified according to a reduced vowel set. However, synchronizing movements of all of the body parts 205, 210, 215 with real-time speech data can create prohibitive complexity in an animation process.

Therefore, according to an embodiment of the present invention, only the lower facial part 210 is animated based on speech data that are classified according to a reduced vowel set. The upper facial part 205, the limb parts 215, and gross motions of the avatar's head—which includes the lower facial part 210 and the upper facial part 205 tilting or rotating together—are animated according to models that are generally independent of speech data. That enables the present invention to animate an avatar in a manner that is significantly less computationally intensive than conventional animation methods. The present invention thus can be performed using real-time speech data, and on a device with limited processor and memory resources, such as the radio telephone 100.

Referring to FIG. 3, a schematic diagram illustrates an animation series 300 including lower facial part visemes 305-i that are used to animate the lower facial part 210 of an avatar, according to an embodiment of the present invention. Speech data that are classified according to the teachings of the present invention can be used to control the motion of mouth and lip graphics on an avatar using techniques such as mouth width mapping according to speech energy, or mouth shape mapping according to a spectrum structure of the speech data. For example, mouth width mapping concerns the opening and closing of a mouth during a peak waveform envelope 310 derived from speech data. Consider where i lower facial part visemes 305-n, numbered from 0 to i−1, are used to describe the peak waveform envelope 310. Mouth width mapping first sets a beginning unvoiced segment of the peak waveform envelope 310 to zero, represented by the closed mouth shown in the lower facial part viseme 305-0. Remaining data frames in the peak waveform envelope 310 are then mapped to the visemes 305-1 to 305(i−1) according to the speech energy in each respective frame, resulting in the fully open mouth shown in the lower facial part viseme 305-9. Finally, to make the perceived motion of a mouth and lips on an avatar appear more natural, post processing of the lower facial part visemes 305-n is performed to provide a smooth transition between visemes 305-n.

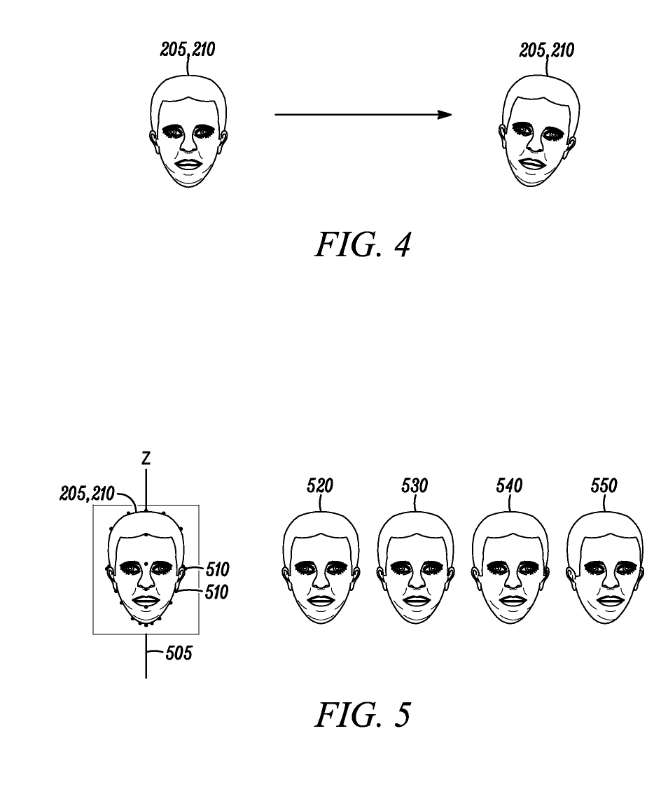

Referring to FIG. 4, a schematic diagram illustrates tilting of a head portion comprising an upper facial part 205 and a lower facial part 210 of an avatar, according to an embodiment of the present invention. An original image of the head portion of the avatar is shown on the left side of FIG. 4. According to the present invention, a Hotelling transform is applied to the image and results in the tilted image of the head portion that is shown on the right side of FIG. 4. According to the Hotelling transform, a center point of the head is first defined. A single parameter θ is then used to specify a rotation transformation. Derivation of the rotation transformation uses basis vectors cos(θ) and sin(θ). Equation 1 below then defines the rotation transformation in terms of rotation of an x-y coordinate axis, where S and D represent source and destination coordinates, respectively.

Sₓ=Dₓcos(θ)+D_{y}sin(θ)

S_{y}=−Dₓsin(θ)+D_{y}cos(θ). Eq. 1

Because Sₓ and S_{y} are generally not integer values, a bilinear interpolation is applied to maintain a smooth transition between animation images. Such bilinear interpolation can use a 2×2 block of input pixels, surrounding each calculated floating point pixel value Sₓ and S_{y}, to determine a brightness value of an output pixel.

Referring to FIG. 5, a schematic diagram illustrates rotation of a head portion comprising an upper facial part 205 and a lower facial part 210 of an avatar, according to an embodiment of the present invention. Such rotation of the head portion of an avatar can be performed using image warping technology, which generates a perception of image rotation-but without requiring any three dimensional model rendering. As is known to those skilled in the art, a Thin Plate Spline (TPS) deformation analysis can interpolate movement of fixed points on a surface. TPS deformation analysis uses an elegant algebraic expression for the dependence of a physical bending energy U of a thin metal plate constrained at various points. That can be visualized as a two-dimensional deformable plate that is pushed up from underneath at given points. Because a height of the plate is fixed at given locations, the plate will deform. The energy required to bend the plate can be defined according to Equation 2 below, which is known as the biharmonic equation.

$${Δ}^{2} U = ( \frac{{\partial }^{2}}{\partial {x}^{2}} + \frac{{\partial }^{2}}{\partial {y}^{2}} ) U = 0 \qquad Eq . 2$$

A fundamental solution to the biharmonic equation is given below in Equation 3:

z(x,y)=−U(r)=−r²logr², Eq. 3

where r is the distance of point (x, y) from the Cartesian origin. The biharmonic equation thus describes the shape of a thin steel plate lofted as a function z(x, y) above the plate, which lies in the (x, y) plane. Equation 3 is thus the natural generalization in two dimensions of the function |x|³. If the displacements z(x, y) are treated as coordinate displacements, the TPS functions of Equations 2 and 3 can be interpreted as interpolation functions, and are thus suitable for two-dimensional image warping.

According to an embodiment of the present invention, a TPS algorithm is used to warp an image of the head of an avatar, including an upper facial part 205 and a lower facial part 210, about a z axis 505. First, a set of control nodes 510 are identified around contours of the upper facial part 205 and lower facial part 210, and along the z axis 505. Coordinate values of the control nodes 510 are denoted as (xᵢ, yᵢ) with i=1, 2, . . . p, where p is the number of control nodes 510. Target coordinate values are then denoted as (xᵢ′, yᵢ′) and are defined according to the following rules: First, target coordinate values of the control nodes 510 along the z axis 505 remain the same as original coordinate values according to Equation 4:

xᵢ′=xᵢ, yᵢ′=yᵢ. Eq. 4

Second, target coordinate values of the remaining control nodes 510 are the sum of the original coordinate values and horizontal offset values according to Equation 5:

xᵢ′=xᵢ+offset, yᵢ′=yᵢ, Eq. 5

where the horizontal offset values belong to the set [−3, −2, −1, 1, 2, 3]. Thus in FIG. 5, the set of four images 520, 530, 540 and 550 on the right side of the figure demonstrate a perceived rotation about the z-axis, where the image 510 is the image before rotation and in the right-most image 550 the avatar appears to be looking toward his left. The four images 520, 530, 540 and 550 correspond to horizontal offset values of 0 (i.e., no rotation about the z-axis 505), 1, 2, 3.

Movements of the upper facial part 205 of an avatar also can be modelled using random models that are generally independent of speech data. For example, images of eyes can be made to “blink” in random intervals spaced around an average interval of ten seconds. Finally, animating torso or limb parts 215 of an avatar also can be performed according to the present invention using random models that are generally independent of speech data.

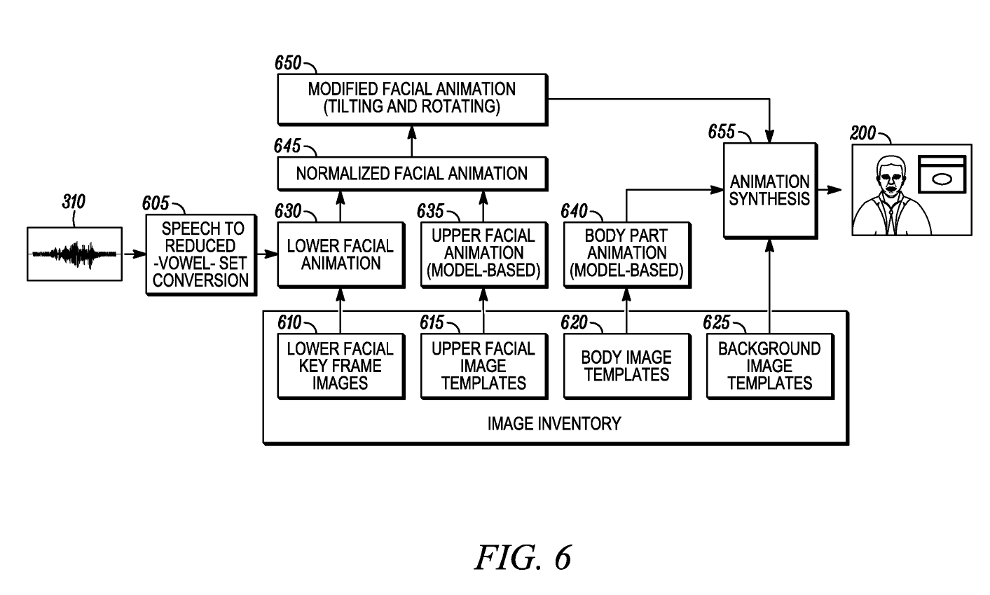

Referring to FIG. 6, a functional block diagram illustrates a method for animating an image, according to an embodiment of the present invention. In block 605 speech data, including a peak waveform envelope 310, are classified into a reduced vowel set. Blocks 610, 615, 620, and 625 represent image inventories that store images such as lower facial part visemes, upper facial image templates, body image templates, and background image templates, respectively. Blocks 630, 635 and 640 represent the independent animation of a lower facial part 210, an upper facial part 205, and limb parts 215, respectively. Note that only block 630, concerning the animation of the lower facial part 210, receives classified speech data directly from block 605; thus blocks 635 and 640 are model-based and operate generally independently of speech data. Block 645 concerns normalized facial animation and block 650 concerns modified facial animation, such as tilting and rotating gross head movements involving both lower facial parts 210 and upper facial parts 205. Finally, in block 655 an animation synthesis is performed resulting in the composite animated image 200.

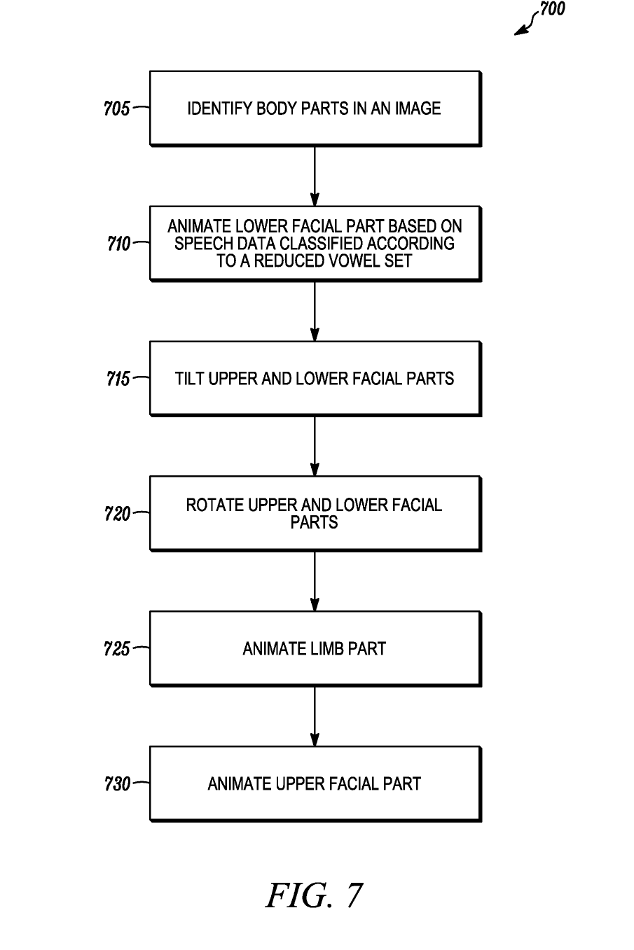

Referring to FIG. 7, a generalized flow diagram illustrates a method 700 for animating an image, such as a cartoon image 200 of an avatar, according to an embodiment of the present invention. First, at step 705 body parts of an avatar, such as an upper facial part 205, a lower facial part 210, and a limb part 215, are identified in the image. At step 710 the lower facial part 205 is animated based on speech data that are classified according to a reduced vowel set. At step 715 a coordinate transformation model, such as a Hotelling transform model, is used to cause gross head tilting movements, including the lower facial part 210 and the upper facial part 205 moving together. At step 720 an image warping model, such as a TPS model, is used to cause gross head rotation movements, including the lower facial part 210 and the upper facial part 205 moving together. At step 725, the limb part 215 is animated using a random model. Finally, at step 730 the upper facial part 205 is animated independently of the animation of the lower facial part 210.

Advantages of the present invention therefore include improved animations of avatars using real-time speech data. The methods of the present invention are less computationally intensive than most conventional speech recognition and animation methods, which enables the methods of the present invention to be executed faster while using fewer processor resources. Embodiments of the present invention are thus particularly suited to mobile communication devices that have limited processor and memory resources.

The above detailed description provides an exemplary embodiment only, and is not intended to limit the scope, applicability, or configuration of the present invention. Rather, the detailed description of the exemplary embodiment provides those skilled in the art with an enabling description for implementing the exemplary embodiment of the invention. It should be understood that various changes can be made in the function and arrangement of elements and steps without departing from the spirit and scope of the invention as set forth in the appended claims. It will be appreciated that embodiments of the invention described herein may be comprised of one or more conventional processors and unique stored program instructions that control the one or more processors to implement, in conjunction with certain non-processor circuits, some, most, or all of the functions of animating an image using speech data as described herein. The non-processor circuits may include, but are not limited to, a radio receiver, a radio transmitter, signal drivers, clock circuits, power source circuits, and user input devices. As such, these functions may be interpreted as steps of a method for animating an image using speech data. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We claim:

1. A method for animating an image, comprising:
identifying an upper facial part and a lower facial part of the image;
animating the lower facial part based on speech data that are classified according to a reduced vowel set;
tilting both the upper facial part and the lower facial part using a coordinate transformation model; and
rotating both the upper facial part and the lower facial part using an image warping model.

2. The method of claim 1, further comprising:
identifying a limb part of the image; and
animating the limb part using a random model.

3. The method of claim 1, wherein tilting and rotating both the upper facial part and the lower facial part are performed independently of animating the lower facial part.

4. The method of claim 1, further comprising animating the upper facial part independently of animating the lower facial part.

5. The method of claim 4, wherein animating the upper facial part comprises generating eye blink images.

6. The method of claim 1, wherein the lower facial part includes a mouth and lips.

7. The method of claim 1, wherein the coordinate transformation model is based on a Hotelling transform according to the following formula:
Sₓ=Dₓcos(θ)+D_{y}sin(θ)
S_{y}=−Dₓsin(θ)+D_{y}cos(θ),
wherein S and D represent source and destination coordinates.

8. The method of claim 1, wherein the image warping model is a Thin-Plate Spine (TPS) model based on the following biharmonic equation:
$${Δ}^{2} U = ( \frac{{\partial }^{2}}{\partial {x}^{2}} + \frac{{\partial }^{2}}{\partial {y}^{2}} ) U = 0.$$

9. The method of claim 1, wherein the image comprises an avatar.

10. The method of claim 1, wherein animating the lower facial part comprises displaying a sequence of visemes.

11. The method of claim 10, wherein each viseme in the sequence of visemes is associated with a phoneme derived from the speech data.

12. The method of claim 1, wherein animating the lower facial part comprises image morphing between images of a closed mouth and images of an open mouth.

13. A method for animating an image, comprising:
identifying an upper facial part and a lower facial part of the image;
animating the lower facial part based on speech data that are classified according to a reduced vowel set; and
animating the upper facial part independently of animating the lower facial part.

14. The method of claim 13, wherein animating the upper facial part is based on data that are different from the speech data.
